(19) United States
(12) Patent Application Publication
(10) Pub. No.: US 2004/0175164 A1
(43) Pub. Date: Sep. 9, 2004

(54) Electrical heating device

(76) Inventors: Irina Loktev, Jerusalem (IL); Igor Papirov, Jerusalem (IL)

Correspondence Address: Gary M. Nath, NATH & ASSOCIATES PLLC, 6th Floor, 1030 15th Street, N.W., Washington, DC, 20005, US

(21) Appl. No.: 10/367,742

(22) Filed: Feb. 19, 2003

(51) Int. Cl. H05B 3/26

(52) U.S. Cl. 392/436; 219/549

(57) ABSTRACT

An electric heating device includes a flexible resistor ribbon of alloy with high specific impedance, disposed in fiberglass or plastics net, forming insert, which is [symbol] .

### FIELD OF THE INVENTION

The present invention generally relates to electric heating devices having a heating element including a heating resistance foil ribbon, intended for radiant beating of premises, building structures (floors, walls etc.), outdoor installations, etc. The invention particularly refers to heating devices with large surface heating elements for heating to relatively low temperatures, which may be used in different domestic, industrial or agricultural installations.

### BACKGROUND OF THE INVENTION

U.S. Pat. No. 6,353,707 discloses an electric heating device of the kind to which the present invention refers, for use in the air and/or for heating a structure. The device comprises an insulating rigid or flexible shell and a flat continuous heating resistance foil ribbon disposed inside the shell. The ribbon extends along the device and is bent in a plurality of locations, where the ribbon has an electroconductive coating for mechanically strengthening and electrically shunting it in these locations.

### SUMMARY OF THE INVENTION

An electric heating device in accordance with the present invention comprises an insulating shell, which may be made of plastics or natural or synthetic rubber, a flexible electric heating element, including a thin flat heating resistance ribbon, disposed inside of said shell, wherein the total area of the ribbon A ribbon, power of the beating element, its geometry, coefficients of heat transfer and temperature conditions meet the following relation:

Aribbon>P/{[(k1+k2)*tribbon max/ksaf]−(k1*t1+k2*t2)}, (1)

where;

A ribbon—the total area of the resistance ribbon;

P—electrical power of the heating element;

k1, k2—coefficients of heat transfer from the heating ribbon to environment from respective sides of the heating element;

$$k1 = 1 / [ ( A ribbon / A ) * ( 1 / ( α 1 + α 2 ) + {\sum }_{i = 1}^{m1} δ i / λ i ) + δ / λ ] , \qquad ( 2 )$$

$$k2 = 1 / [ ( A ribbon / A ) * ( 1 / ( α 3 + α 4 ) + {\sum }_{j = 1}^{m2} δ j / λ j ) + δ / λ ] , \qquad ( 3 )$$

(for heating devices disposed with air on two sides) or

$$k2 = 1 / [ ( A ribbon / A ) * ( {\sum }_{j = 1}^{m2} δ j / λ j ) + δ / λ ] \qquad ( 4 )$$

(for heating devices having a heated structure at least on one side),

t ribbon max—a maximal temperature of the resistance ribbon, which is admissible for said shell;

k saf—safety factor determined considering possible rising of voltage, deterioration of conditions of thermo-dissipation, fuzzy operating of thermostats system and it is normally in the range of 1.1-1.8 (the choice of the safety factor in the indicated range assures that the foil temperature never exceed a given operating temperature of the shell regardless of exterior temperature or voltage surges);

t1, t2—temperatures of environment on respective sides of the heating device, or the structure to be heated;

A—total area of the shell;

α1, α3—coefficients of heat transfer by convection from two different sides of the beating device or the structure to be, heated, which border with air;

α2, α4—coefficients of heat transfer by heat radiation from two different sides of the heating device or the structure to be heated, which border with air;

λ, δ—respectively, coefficient of heat conductivity and thickness, of the shell material or, if the shell has more than one layer, of the material of the layer directly contacting with the resistance ribbon;

i, j—order number of a layer from of the structure to be heated, on a respective side of the heating device,

m1, m2—total number of the layers of the heated structure from, respectively, first and second side of the heating device.

In the heating device of the present invention, temperature of the ribbon, temperature of the shell), specific power of the heating element, exploitation conditions and configuration of the ribbon, i.e. a total area of the ribbon and relation between this area and the area of the shell, are so connected as to ensure that in the most dangerous places from overheat standpoint (places of contact between the shell and the heating resistance ribbon) overheating is avoided, whereby life time and reliability of the heating device may be essentially increased.

The relation presented above enables to determine die distribution of the ribbon in the heating device based on the properties of all materials involved (those of the heating device and of its environment including the structure to be heated). Thus, based on the total area A ribbon defined in accordance with relation (1), length L ribbon, and width, W ribbon of the ribbon may be defined as follows:

L ribbon=✓R ribbon*δribbon*A ribbon/ρribbon (5)

W ribbon=A ribbon/L ribbon (6),

where:

R ribbon—electrical resistance of the ribbon corresponding to power of the heating element;

δ ribbon—thickness of the ribbon;

ρ ribbon—specific resistance of the ribbon.

With the ribbon, length and width having values equal or close to those in the equations (5) and (6), a required degree of distribution uniformity of the overall temperature throughout the entire heating device may be achieved.

Preferably, the heating resistance ribbon is a metal foil ribbon having the above dimensions, which is preferably capable of being bent and arranged by meandered pattern.

The present invention further proposes a composition of an alloy for use in resistive foil, which provides simultaneously sufficient plasticity, strength and high specific electric impedance, enabling the foil to be produced with a desired thickness and to be bent to a desired configuration. Such alloy or group of alloys has the following component elements with the relative weights listed in percentage of total weight:

13.5-15.5% chromium;

4.5-6.5% aluminium

0.3-1.1% silicon

0.2-0.6% titanium,

0.01-0.1% cerium.,

a balance of said alloy comprising iron with natural admixtures.

wherein the chronium content and aluminum content are related to one another by the inequality: 17<X<21.0, wherein X=% Cr+% Al.

The alloy of the present invention is characterized by a plasticity permitting cold rolling into a foil with thickness within 50-20 microns. For increasing of the alloy plasticity, zirconium may be added (to 0.01%). Foil thickness within 20-10 microns may be obtained in narrow limits of components content: 18.2<X<21 and particularly 18.8<X<20.5.

For using in heating devices, the foil is cut into ribbons. Each ribbon, due to the high plasticity of the foil, may be bent back on itself, i.e with a zero angle. The ribbon may be bent also to other angles. Bending radius may both exceed, or be less than triple thickness of the ribbon. Bending radius may even be practically equal zero. This property gives possibility to cover large area of a heating device by one ribbon without intermediate connections and so considerably increases reliability of the device.

A resistance foil ribbon made of the alloy of present invention, may contain also additional coating of electric enamel. In heating devices where the ribbon is used as a heating element disposed within an insulating (plastic or rubber) shell, such coating serves as a second insulation layer. When the shell is made of rubber, vulcanized together with the heating element, this solution is very important, because using of plastics insulation as a second layer in vulcanization conditions (temperature more 160° C.) is difficult.

A further aspect of the present invention is a universal heating element for incorporation in any plastics or rubber shell. Such element comprises a basic material supporting the resistance ribbon such as to enable the element to be produced, as an insert, separately from the shell either as a body insertable into said shell, or as a body adapted for impregnation by melting polymer or rubber mass, to form said shell, said ribbon being made from the metal alloy. Such insert is used both as a heating element and as a reinforcing material. Said impregnation may be performed during the process of incorporation of the insert in the shell. Synthetic or fiberglass mesh or fiberglass mat may be selected as the basic material.

This insert may be supplied to the manufacturer of a finished product (entire heating device, including plastics shell) to be inserted in the shell during their own production process.

The present invention proposes also some very specific technologies to attach the foil ribbon to the basic material.

In accordance with this invention layers of the insert and the heating ribbon are jointed together by spots of glue, which belongs to a group of cyan-acrylate glues and which is polymerized due to pressing. Area of the heating ribbon is larger than area of the glued places, contacting with the ribbon, in three and more times.

In another alternative specific configuration of the heating device layers of said insert and the heating ribbon are jointed together by thermoplastic strips preferably from P.V.C.), crossing the heating ribbon. These strips are melted and crowded to some places on the heating ribbon and on the insert layers in joining process. Melting temperature of this thermoplastic material is lower than melting temperature of insert basic material. Area of the heating ribbon is larger than the area of said places, contacting with the ribbon, in three and more times.

In yet another alternative specific configuration the insert is made as harder structure. In this case layers of the insert and the heating ribbon are jointed together and sealed by polymer (preferably from liquid P.V.C.), which adheres to insert basic material and does not adhere to the heating ribbon. The temperature of adhesive polymerization is lower than melting temperature of the insert basic material.

In cases of heating devices with thin flexible shell, the insert consists of one layer of the basic material and the heating ribbon. The heating ribbon is jointed with said basic material by one of said means: by parts of glued double sided strips, disposed on said heating ribbon, or by spots of a cyan-acrylate glue, disposed on said heating ribbon, or by thermoplastic strips (preferably from P.V.C.). In this case also the area of the heating ribbon is larger than the area of said glued places, contacting with the ribbon., in three and more times.

The heating ribbon may be located also directly on flexible thermoplastic sheet. In this case the heating ribbon is jointed with the sheet by pressing and heating of some points along the said ribbon to a temperature of melting of this sheet. Area of the heating ribbon is larger than the area of said heated places in three and more times.

In accordance with the present invention, the insert is incorporated into a plastics shell during the production process of manufacturer of the entire heating device. In particularity, insert is incorporated into a plastics shell during the calendering process or laminating process, joining the thermoplastic sheets. This process is usually applied in the manufacturing of flexible P.V.C. sheets for floors. Incorporating of the heating insert into rubber shell is made during vulcanization process.

Incorporation of the heating insert into plastics sheaths during extrusion process opens new directions in heating techniques. This technology allows to obtain strips for very long distances up to 3-5 km. In this case the insert comprises the heating ribbon and two additional electro-conductive metal ribbons, which are located from two sides of said heating ribbon. Electro-conductive metal ribbons are used as bus-bars, A distance between the bus-bars and the heating ribbon is not less of the distance required by electrical insulation strength. Bridges connect the heating ribbon with bus-bars, forming longitudinally extending parallel resistances. Maximum length of the strip is defined by permissible volume of voltage drop on bus bars.

This technology allows also to obtain the heating strip, which may be cut through minimum length. In this case the insert, incorporated in extruded plastics sheath, contains bus-bars, made as flexible metal ribbons, disposed along of said insert, and the beating ribbon. The heating ribbon forms multitude of heating sections. Each of the heating sections is connected with said bus-bars in parallel. The strip may be cut after each section in dependence on required electrical power and length. Minimum length of cut strip is length of one such section.

The present invention proposes also some available schemes of electrical connections of the heating devices in a form, of heating sheets. In one of these schemes ends of the heating resistor ribbon are connected with electro-conductive bus-bars, which, are made as a flexible metal ribbon and are disposed along of the plastic sheets and perpendicularly to the heating ribbon lines. The bus-bars are finished by terminals, which are disposed from two sides of the heating device and form at least two pairs for connections of several heating devices one to other and is with power supply.

The second scheme allows to improve reliability of the heating device by forming of multitude of the heating sections within one heater. Each of the heating sections is connected with the bus bars in parallel, and the heating device may be cut in dependence on required electrical power. In the case of destruction of one of the sections (for example, as a result of mechanical damage from nails, screw etc.), other sections continue operate without unsealing of whole heating device.,

The present invention proposes some specific applications of the heating device.

The heating devices can be used as different radiant heaters with large area, for example, as P.V.C. covering on floors. Due to the low surface temperature and especially to the even distribution, the heating devices do not excite temperature deformations and can be used under wood. Therefore the heating devices are recommended for floor heating and for heating of other building structure elements. Plywood, gypsum walls panels, ceramic tiles and others are used as a rigid base.

In this case the plastics shell is tightly mechanically joined with one side of the rigid base, and together they form a heating structure, such as heating wood floor or heating wall or heating ceiling. Gluing or mechanical connections are available for joining of the plastics shell and the rigid base. Pairs of terminals from two sides of the beating device can electrically connect the heating devices each with others.

Protection from nails, screws etc. may be realized by marking of external side of the rigid base, indicating the disposition of the heating device behind. Other method to prevent using of different fastener goods in heater zone is to make preliminarily openings for nails on the rigid base. Third method is using both of the marking and of plastics nails. If a nail hits on space between the heating ribbons, due to proposed design of heating device the heating device does not lose its water-proofness and continues operation. If a nail get to any heating ribbon, the ribbon can fall (and can do not fall) and one of heating sections does not operate. But the whole heating device, due to proposed design of heating device, also does not loose its water-proofness and continues operation. Electrical potential can not hit on external surface of the floor through plastics nail, and further operation is not dangerous.

The plastics shell may be tightly glued with one side of a flexible base, and together they form a heating device, such as heating carpet or pad.

The described heating device may be used also for heating of different structures, made from resins. In this case the insert is disposed between layers of resin, for example, polyester or epoxy, and the insert serves simultaneously as reinforced material. All layers are polymerized, forming different heating flat or three-dimensioned structures, for example, chemical tanks, made from fiberglass reinforced thermoset plastics. In this case the insert are disposed between layers of glass reinforced resin, such as polyester or epoxy. The insert is here simultaneously one of reinforced plastics material, and all layers are polymerized simultaneously, forming the heated tank. Using of the heating insert built in chemical tank creates the safe heating structure, providing ability of operation, storage and transportation of different liquid dangerous or aggressive materials.

Other application of the described heating device is a waterproof strip, which can be used as snow melt devices, heated roof gutters, etc. The strip contains plastics sheath and the heating ribbon. There are some options of strips structures: plastics sheath may be made of shrinkable sleeve or extruded, the heating ribbon may be enameled or not. The strip may contain also two extruded sheaths.

One of preferred variant is the extruded heating strip, which contains additional metal ribbon. This additional ribbon is made of high conductive metal and serves as a bus bar. It is possible also to make the additional ribbon as the second heating ribbon. In this variant the strip has connector on one end.

For heating of area the heating strip is arranged as a mat. For bending of the strip, made of thermoplastic material, places of bending is heated and pressed. In the invention it is described also other design of an extruded strip, which comprises the heating ribbon., two additional ductile wires incorporated in extruded plastics sheath simultaneously with the heating ribbon during the same extrusion process and located from two sides of said heating ribbon. The additional ductile wires “keep in mind” a shape of bended-strip and provide easy bending of the strip in the heating mat. Simultaneously, the additional wires may be used as a bus-bar, and the heating mat has connector on one end. For mechanical fastening of the mat it is preferably to use narrow plates as a ruler with pins for the strip lines fastening. For mechanical fastening it is possible to use also net.

The present invention proposes also other type of a heating strip, wherein, the heating ribbon is coated by a layer of thermo-conductive liquid silicon rubber mass. The heating ribbon may be enameled.

The present invention, therefore, aims to obtain an universal heating element with unlimited dimensions for incorporation to any flexible and rigid plastics shells, ability to utilize many materials with low heat tolerances as vehicles for many applications, with the added benefit of an increased life-span and the highest reliability.

All these goals can be attained using the proposed new electric heating element, intended for incorporation in different flexible and rigid plastics.

The present invention provides technical solutions, which are innovative and capable of meeting the requirements for their application. The technical solutions are fit for industrial production, and as formulated in the present patent application, constitute a coherent invention.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is schematic top perspective view of a heated floor structure with a heating device in accordance with the present invention;

FIG. 2 is schematic top view of one embodiment of an insert in accordance with the present invention;

FIG. 3 is schematic top view of another embodiment of an insert according to the present invention;

FIG. 4 is schematic top view of a layer of a flexible thermoplastic sheet used as an insert basic material;

FIG. 5 is schematic top view of an extruded heating strip for long distance;

FIG. 6 is schematic top view of an extruded heating strip with heating sections;

FIG. 7 is scheme of a floor structure with one row of heating sections;

FIG. 8 is scheme of a floor structure with a plurality of rows of beating sections;

FIG. 9 is schematic top view of a heated wood floor structure;

FIG. 10 is schematic perspective view of a heated chemical bath with an insert of the present invention, mounted into the bath;

FIG. 11 is schematic perspective view of an, extruded strip of the present invention, with additional wires;

FIG. 12 is schematic top view of a heating mat according to the present invention;

FIG. 13 is schematic top of a heating strip with silicon rubber shell;

FIG. 14 is schematic top of a heating rubber mat for outdoor installation and its cross section;

FIG. 15 is table of test results of an experimental sample of a heating device designed according to the present invention.

### DETAILED DESCRIPTION OF THE INVENTION

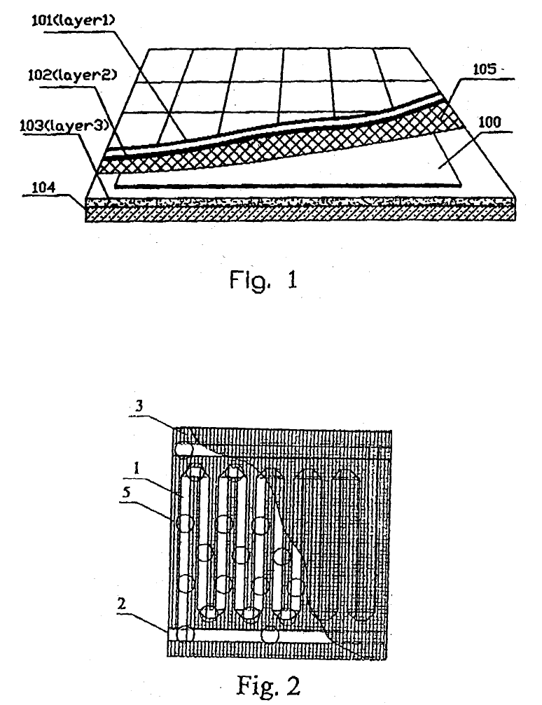

The invention shows different variants of using of the heating element. FIG. 1 illustrates an example of heated floor structure with proposed heating device 100. This structure has the following layers: ceramic tiles 101 (layer 1), cement 102 (layer 2), proposed heating device 100, thermo-insulation 103 (layer 3) and concrete base of floor (sub-floor) 104.

The layer of cement is fastened by reinforcing and grounding metal net 105. The heating device 100 consists of a plastics shell and of a heating insert. The heating insert is shown in FIG. 2. The heating insert consists of the resistance ribbon 1, connected with bus-bars 2, which is disposed on the insert basic material 3. Fiberglass or synthetic mesh or mat may be used as basic material.

Calculation of area A ribbon of the resistance ribbon 1 for the floor structure, shown in FIG. 1, is performed by equation (1):

A ribbon>P/{[(k1+k2)*t ribbon max/k saf]−(k1*t1+k2*t2)}, (1)

where:

A ribbon—a total area of the heating ribbon in heating device;

P—electrical power of the heating element;

k1, k2—coefficients of heat transfer from the heating ribbon to environment from respective sides of the heating element;

k1=1/[(A ribbon/A)*(1/(α1−α2)+δ1/λ1+δ2/λ2)+δ/λ] (2)

k2=1/[(A ribbon/A)*(δ3/λ3)+δ/λ] (4)

where:

t ribbon max—a temperature of the heating ribbon, which is maximum admissible for a plastics shell,

k saf—safety factor, considering possible rising of voltage, deterioration of thermo-dissipation conditions, fuzzy operating of thermostats system, etc.; k saf is in limits 1.1-1.8.

t1—temperatures of air;

t2—temperatures of sub-floor;

A—a total area of a shell in a heating device;

α1—coefficient of heat transfer by convection;

α2—coefficients of heat transfer by heat radiation;

λ, δ—respectively, coefficient of heat conductivity and thickness, of the shell material or, if the shell has more than one layer, of the material of the layer directly contacting with the resistance ribbon;

λ1, λ2, λ3—coefficients of heat conductivity of the layer 1 (ceramics tiles), layer 2 (cement), layer 3 (thermo-insulation), correspondingly;

δ1, δ2, δ3—thickness of the layer 1 (ceramics tiles), layer 2 (cement), layer 3 (thermo-insulation), correspondingly;

Length and width of the ribbon are defined in accordance with relations (5), (6):

L ribbon=✓R ribbon*δribbon*A ribbon/ρribbon (5)

W ribbon=A ribbon/L ribbon (6)

where:

R ribbon—electrical resistance of the ribbon corresponding to power of the heater P;

δ ribbon—thickness of the heating ribbon;

ρ ribbon—specific resistance of the heating ribbon foil;

The example of calculation of the heating device geometric parameters is shown below.

It is preferably to make the resistance ribbon of the metal alloy, which possesses all properties, which are necessary for heaters with high reliability and long life span, high electrical resistance (more 1 micro-Ohm*m), minimum thickness 10-20 microns, bend ability (bending with radius equal zero), operating temperature more 700° C. for possibility of soldering and welding. Such alloy has the following component elements with the relative weights listed in percentage of total weight:

13.5-15.5% chromium;

4.5-6.5% aluminium

0.3-1.1% silicon

0.2-0.6% titanium,

0.01-0.1% cerium,

a balance of said alloy comprising iron with natural admixtures;

If in this alloy the chromium content and aluminum content are related to one another by the inequality: 17<X<21.0, wherein X=% Cr+% Al. The alloy is characterized by a plasticity permitting cold rolling into a foil with thickness within 50-20 microns. For increasing of alloy plasticity zirconium may be added (to 0.01%). Foil thickness within 20-10 microns may be obtained in narrow limits of components content: 18.2<X<21 and particularly 18.8<X<20.5.

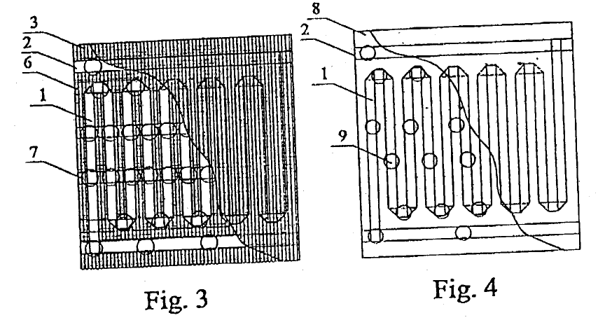

FIG. 2, FIG. 3 show different variants of hating insert design; FIG. 2 illustrates a heating insert with layers from mesh. The heating ribbon 1, connected with bus-bars 2, is disposed on the insert basic material 3. Fiberglass or synthetic mesh or mat may be used as basic material. Gluing materials must no influence on whole heating device and do not create additional problems of impregnation, by molten polymer in the manufacturing process. Therefore it is important to limit contents of gluing materials and to keep correlation: an area of the heating ribbon is larger than the area of the glued places, contacting with the ribbon, in three and more times. In FIG. 2 the heating insert is joined by spots of glue 5, which belongs to a group of cyan-acrylate glues. For quick polymerization it is enough to press a glued place. Using of this glue facilitates design of machine for ribbon arranging and insert joining. In this case area of the heating ribbon also must be larger than the area of said glued places, contacting with the ribbon, in three and more times.

FIG. 3 shows a heating insert, in which thermoplastic strips 6 (preferably from P.V.C. or polyethilene) are used for insert layers and heating ribbon joining. Thermoplastic strips 6 are melted and crowded to some places 7 on the heating ribbon, and on the insert layers 3 in joining process.

If the heating device has plastics shell made from thermoplastic material, for example, from P.V.C. sheets or polyethylene film., one of these sheets may be used as the insert basic material. In some cases the heating devices have no necessity of additional reinforced materials. Then the heating ribbon is joined directly with the basic material (FIG. 4). This joining is made by pressing and simultaneously heating of some points 9 (or cross lines) along the ribbon. 1 to a temperature of melting of the thermoplastic basic material 8.

Laying of the heating ribbon on insert or any basic material is considerably simplified, if this laying is realized on magnet tables. In this case number of gluing and fastening places considerably decreases.

The insert is incorporated into a plastics shell, during the production process of manufacturer, in particularity, during continuous calendering process or continuous laminating process, which is usually applied in the manufacturing of flexible P.V.C. sheets for floors. During laminating process the insert is disposed between layers of thermoplastic hot sheets and pressed by hot rolls.

The heating insert may be also incorporated inside plastics sheath during continuous extrusion process. In this case continuous heating strip may be obtained.

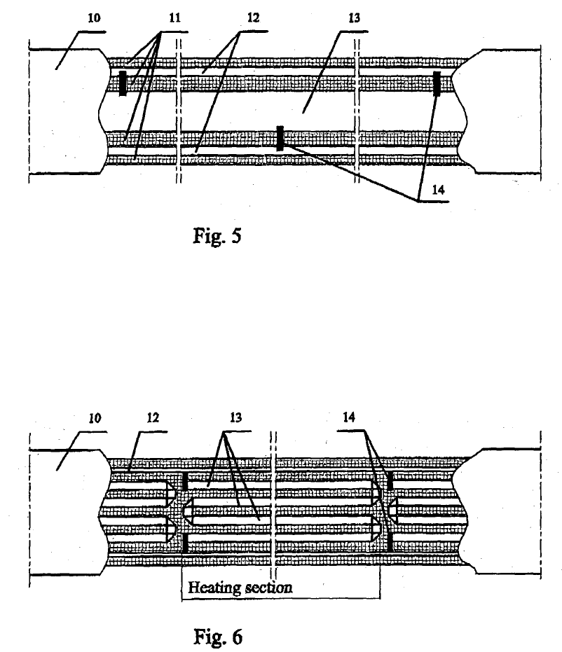

This strip can solve a problem of long heating lines with length up to 5 km. FIG. 5 shows long extruded strip, which comprises extruded sheath 10, and heating insert. The heating insert consists of net 11, two additional electro-conductive metal ribbons 12 and a heating ribbon 13. Electro-conductive metal ribbons 12 are used as bus-bars. All ribbons are incorporated in extruded plastics sheath simultaneously during the same extrusion process. Special tooling in extruder head contains separate slots for each ribbon., and the ribbons are spaced out. The bus-bars 12 are located from two sides of said heating ribbon 13. Bridges 14 connect the heating ribbon with bus-bars, forming longitudinally extending parallel resistances in a heating strip for long distance.

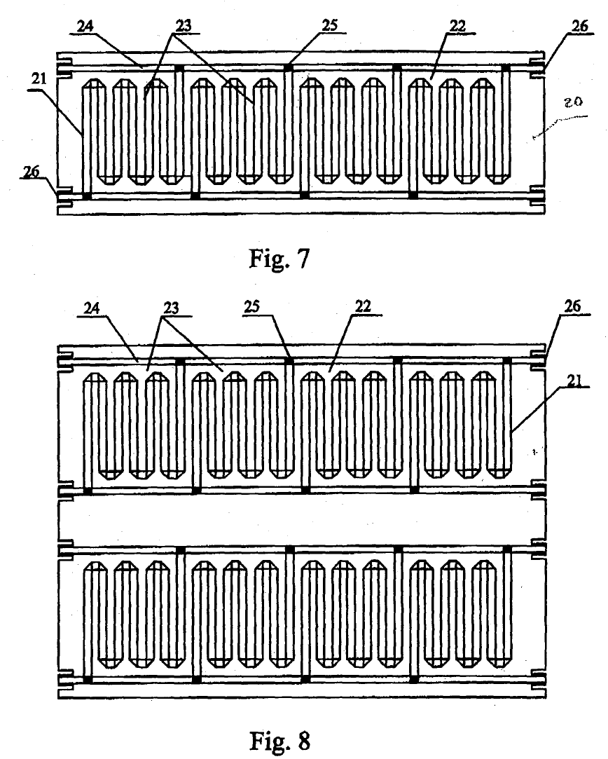

FIG. 6 shows a strip, which is intended for relatively short distances. The strip contains an extruded sheath 10 and a heating insert, made on a base of net 11. The bus-bars are disposed along of the insert. The heating ribbon is arranged such, that it forms parallel heating sections. Each of them is connected to bus-bars 12 by bridges 14. Obtained continuous flexible heating strip may be cut after each section in dependence on required electrical power and length.

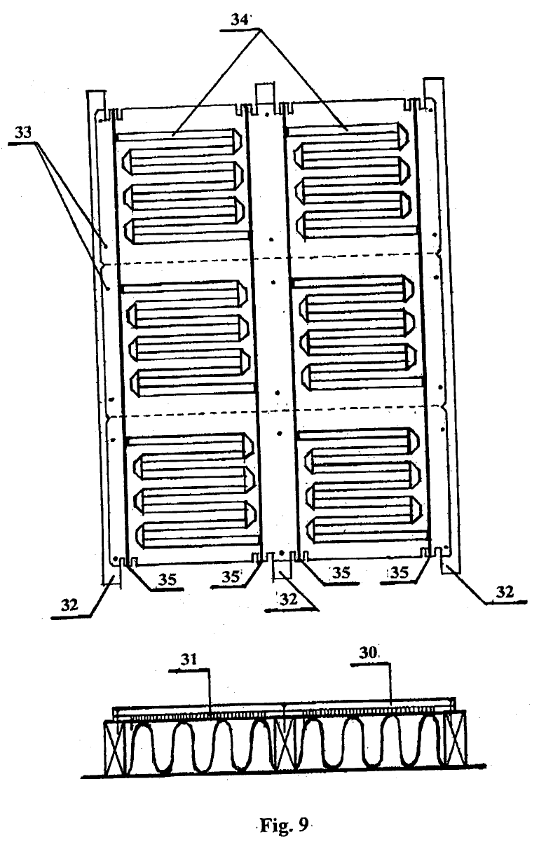

In the same way an electrical heating device in a form of flexible sheet may 30, be built. Such beater is shown in FIG. 7. The heating insert lies between flexible plastics or rubber or silicon sheets 20 (upper sheet is conditionally absent). The insert comprises the heating ribbon 21, disposed between layers of net 22. The heating ribbon is laid on multitude sections 23, and each of these sections is independent beater, connecting with bus-bars 24 in points 25. A manufacturer produces continuous roll., which after that is cut between sections 23 in accordance with required power and area. Such heating device has terminals. 26 from two sides. The ready heater contains some these sections.

FIG. 8 illustrates the heating device, which contains two rows of sections 23 and each row have two pairs of connectors 26.

FIG. 9 illustrates heated wood floor structure, consisting of plywood 30 and the heating device 31, glued to the plywood from lower side. This plywood together with the heating device is fastened to the joists 32 by nails 33. In one of options space for nails is marked on upper side of the plywood. In other option the plywood and the heating device contain openings for nails, prepared beforehand. The heating device consists of heating sections 34. Pairs 35 of terminals from two sides of the heating device can electrically connect the heating devices each with others or with power supply.

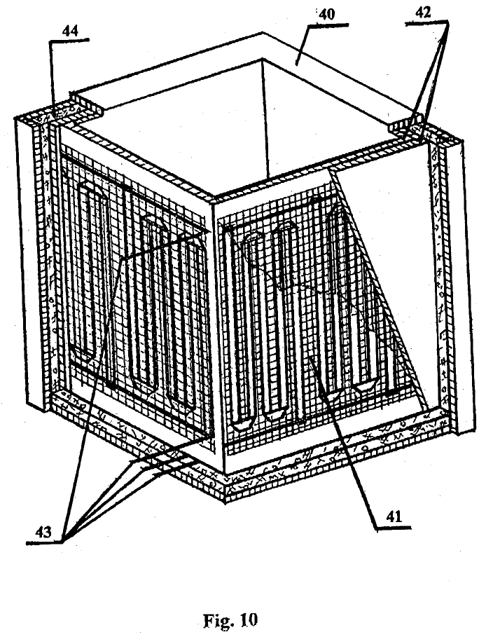

FIG. 10 shows a heating chemical tank 40 made from fiberglass reinforced thermoset plastics. The insert 41 is disposed between layers 42 of glass reinforced resin plastics, such as polyester or epoxy resins. The electrical terminals 43 are connected with power supply. Layer of thermo-insulation may be disposed around the tank.

The invention describes some types of strips, made on base of the heating ribbon: the heating ribbon., incorporated in a shrinkable sleeve or in extruded sheath; the enameled heating ribbon, also incorporated in a shrinkable sleeve or in extruded sheath; the heating ribbon, incorporated in double extruded sheaths. One of preferred designs is strip with two ribbons, which are extruded simultaneously. One of them is the heating ribbon. The second ribbon may be also the beating ribbon or metal ribbon with high electro conductivity, which is used as a bus-bar. This strip type provides connection to power supply from one end of the strip.

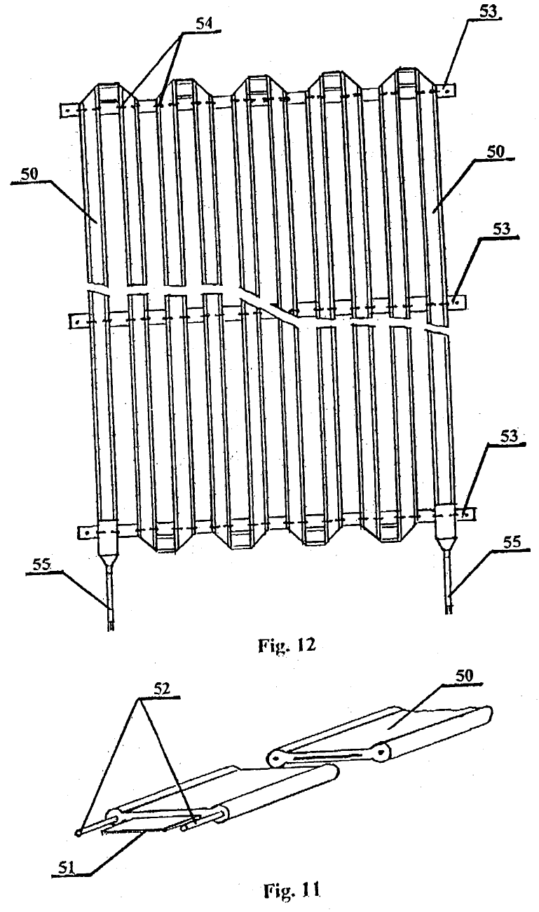

FIG. 11 illustrates other type of a heating strip, which comprises an extruded plastics sheath 50, the heating ribbon 51 and two additional metal wires 52, incorporated in extruded plastics sheath, 50 simultaneously with the heating ribbon during the same extrusion process. The additional wires can perform two functions. The first, the wires is made from ductile material and provides easy bending of the strip in a shape of a heating mat. The second, the wires may be used as bus-bars.

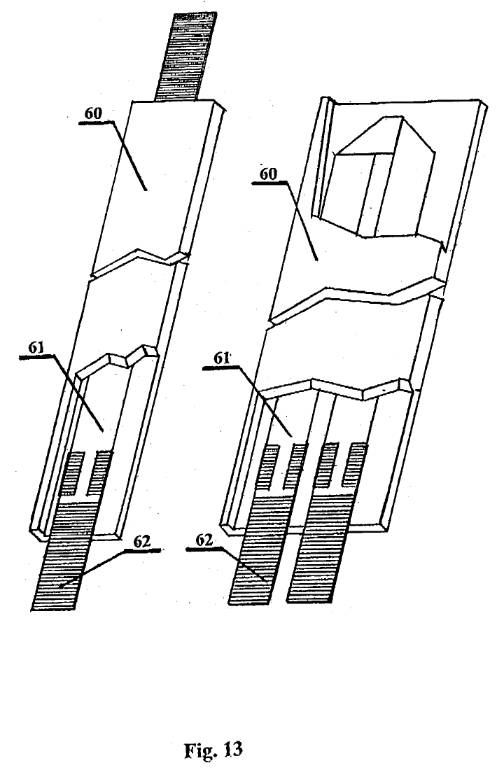

A heating mat is shown in FIG. 12. The mat consists of the heating strip, which is bent in a shape of a heating mat. If the mat is made of a strip without ductile additional wires, the bending is realized by heating and pressing of the strip in bending places. If the mat is made of a strip with ductile additional wires, bending process need not heating and pressing. All, strip lines are jointed in the mat, by narrow plates as a ruler 53 with pins 54 for said strip lines fastening. Ends of the strip contain connectors 55 for connection with electrical cable.

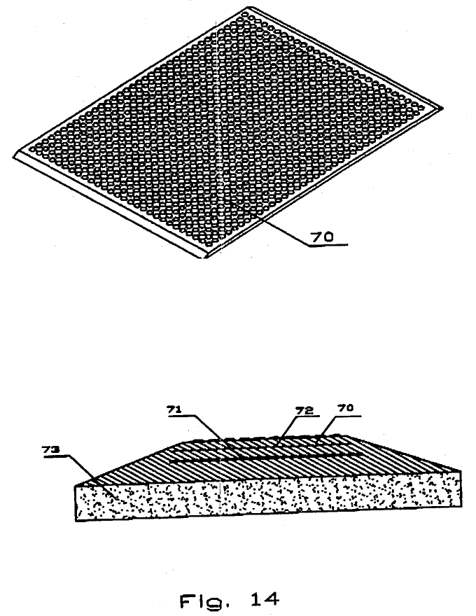

FIG. 13 shows heating strips, which are coated by layer of thermo-conductive liquid silicon rubber mass 60. Heating ribbon 61 contains connectors to power supply 62 on two ends or on one end. The heating ribbon may be coated by electric enamel.

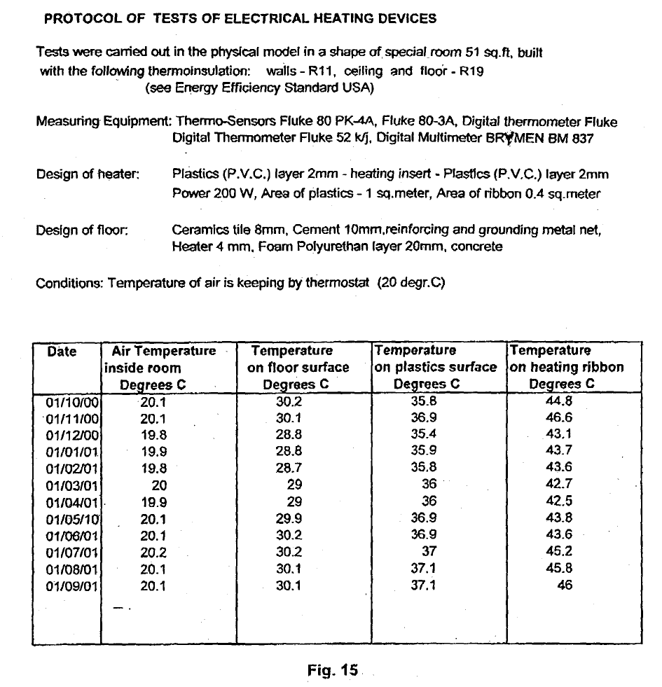

FIG. 14 shows a sample of a heating device for outdoor installation with vulcanized rubber shell 70. The heating device contains the heating insert 71, metal net for grounding 72 and thermo-insulating layer 73.

For example we will calculate area of the heating ribbon for floor heating device, shown in FIG. 1.

### EXAMPLE

Data of floor heater:

Power of the heater Pa 200 W,

Total area of a plastics shell in the heating device, A=1 sq. meter,

Thickness of the insulating plastics shell from each side of the heating ribbon δ=0.002 m,

Coefficient of heat conductivity of plastics material in said plastics shell λ=0.2 W/(m*° C.),

The heated floor consists of the following layers (top-down):

a) ceramic tiles, thickness δ1=0.008 m, heat conductivity λ1=0.4 W/(m*° C.),

b) cement layer, δ2=0.010 m, λ2=0.9 W/(m*° C.),

c) above mentioned plastics heater, δ=0.002 m, λ=0.2 W/(m*° C.),

d) layer of thermo-insulation, δ3=0.020 m, λ3=0.024 W/(m*° C.),

e) base of the floor (concrete).

Given conditions of operating:

Temperature of air in a heated room t1=20° C.,

Temperature of the base of the floor t2=10° C.,

Temperature of floor surface t surf=30° C.,

Temperature of the heating ribbon, which is maximum admissible for a used plastics shell

t ribbon max=80° C.,

Safety factor k saf =1.8.

Calculation:

Coefficient of heat transfer by convection in accordance with approximate formulas of Nusselt for natural convection, horizontal surface in air (Hand-book HUTTE, book I, page 496, Mitt. Forschungsarb copy-book 63/64, page 82) is equal:

α1=2.3⁴✓(tsurf−t1)kcal/(m²h° C.)=3.2⁴✓(30−20)=5.7 W/(m²° C.).

Coefficient of heat transfer by radiation:

α2=εCs*1*[(Tsurf/100)⁴−(t1/100)⁴]/(tsurf−t1)=5.74*0.7*[(303/100)⁴_{_{—}}(293/100)⁴]/(30−20)=4.26 W/(m²*° C.);

where: Cs=4.96 kcal/m² h(÷abs)⁴=5.74 W/m² h(÷abs)^{4 (}Stephan-Boltzman constant),

ε—relative absorption capacity; for our plastics 1ε=0.7;

Coefficients of heat transfer from upper and lower sides of the heater are equal:

k1=1/{(Aribbon/A)*[1/(α1+α2)+δ1/λ1+δ2/λ2]+δ/λ}

k2=1/[(A ribbon/A)*δ3/λ3+δ/λ];

Calculation is performed by the iteration method.

It is received Aribbon/A=0.43.

k1=1/{0.43*[1/(5.7+4.26)+0.008/0.4+0.010/0.9]+0.002/0.2}=15.15 W/(m²*° C.)

k2=1/[0.43*0.02/0.024+0.002/0.2]2.74 W/(m²*° C.)

Aribbon>=200/[(15.15+2.74)*80/1.8−(15.15*20+2.74*10)]=0.43 m²

Checking of received volume Aribbon/A: Aribbon/A=0.43/1.0=0.43.

Thus, in this example coverage of heating ribbon is 43%.

Experiment, carrying out by Inventors, shows, that heating element, built in, limits, pointed in the, present invention, has high reliability and high stability as it is shown in the table in FIG. 15.

The invention has been described in an illustrative manner, and it is to be understood that the terminology, which has been used, is intended to be in the nature of words of description rather than of limitation. Clearly, many modifications and variations of the present invention are possible in light of the above teachings. For example, total area A of the flexible resistor ribbon is in limits, defined by equation (1), and this fact provides high reliability and life span of the heating device. Accordingly, it is to be understood that die invention can practiced otherwise than specifically described.

1. An electrical heating device, for use in the air and/or for heating a structure, which device comprises:
a insulating rigid or flexible shell, a flexible electric heating element including a flat continuous heating resistance ribbon, disposed inside the shell, wherein total area of the resistance ribbon meets the equation:
A ribbon>P/{[(k1+k2)*t ribbon max/k saf]−(k1*t1+k2*t2)}, (1)
where:
A ribbon—the total area of the resistance ribbon;
P—electrical power of the heating element;
$$k1 = 1 / [ ( A ribbon / A ) * ( 1 / ( α 1 + α 2 ) + {\sum }_{i = 1}^{m1} δ i / λ i ) + δ / λ ] , \qquad ( 2 )$$
$$k2 = 1 / [ ( A ribbon / A ) * ( 1 / ( α 3 + α 4 ) + {\sum }_{j = 1}^{m2} δ j / λ j ) + δ / λ ] , \qquad ( 3 )$$
(for heating devices disposed with air on two sides) or
$$k2 = 1 / [ ( A ribbon / A ) * ( {\sum }_{j = 1}^{m2} δ j / λ j ) + δ / λ ] \qquad ( 4 )$$
(for heating devices having a heated structure at least on one side),
t ribbon max—a maximal temperature of the resistance ribbon, which is admissible for said shell;
k saf—safety factor determined considering possible rising of voltage, deterioration of conditions of thermo-dissipation, fuzzy operating of thermostats system;
t1, t2—temperatures of environment on respective sides of the heating device, or the structure to be heated;
A—total area of the shell;
α1, α3—coefficients of heat transfer by convection from two different sides of the heating device or the structure to be heated, which border with air;
α2, α4—coefficients of heat transfer by heat radiation from two different sides of the heating device or the structure to be heated, which border with air;
λ, δ—respectively, coefficient of heat conductivity and thickness of the shell material or, if the shell has more than one layer, of the material of the layer directly contacting with the resistance ribbon;
i, j—order number of a layer from of the structure to be heated, on a respective side of the heating device,
m1, m2—total number of the layers of the heated structure from, respectively, first and second side of the heating device.

2. The electrical heating device of claim 1,
wherein a length L ribbon and a width W ribbon of said ribbon meets the correlations:
J ribbon=✓R ribbon*δribbon*A ribbon/ρribbon (5)
W ribbon=A ribbon/L ribbon (6)
where:
R ribbon—electrical resistance of the ribbon corresponding to power of the heating element P;
δ ribbon—thickness of the ribbon;
ρ ribbon—specific resistance of the ribbon material;

3. The electrical heating device of claim 1,
wherein the resistance ribbon is a metal foil ribbon with a thickness less than. 50 microns, electrical resistance exceeding 1.0*10⁻⁶ Ohm*m and with increased plasticity, allowing to bend the ribbon in any required pattern at the angle within 0-90°.

4. A high electrical resistance alloy suitable for processing into micro-dimensioned foils, consisting essentially of, by weight:
13.5-15.5% chromium;
4.5-6.5% aluminum;
0.3-1.1% silicon;
0.2-0.6% titanium;
0.01-0.1% cerium; and
a balance of said alloy comprising iron with natural admixtures;
wherein said chromium and said aluminum are of amounts which together satisfy the following relation: 17<X<21, wherein X=% Cr+% Al

5. The alloy of claim, 4, which contains additionally to 0.01% zirconium.

6. The alloy of claim 4,
further characterized by a plasticity permitting cold rolling into a foil from 50 microns up to 20 microns thickness or less.

7. The alloy of claim 4, wherein. 18.2<X<21

8. The alloy of claim 4, wherein 18.8<X<20.5

9. The alloy of claim 8,
further characterized by a plasticity permitting cold rolling thereof into a foil from 20 microns up to 10 microns thickness or less.

10. An electric heating device including a flexible electrical heating resistance ribbon made of an alloy according to claim 4, capable of being bent back on itself.

11. The electric heating device, of claim 10, wherein said flexible electrical heating resistance ribbon is capable of being bent at any angle with radius of ribbon bending, exceeding triple thickness of the ribbon.

12 The electric heating device of claim 10, wherein said flexible electrical heating resistance ribbon is capable of being bent at any angle with radius of ribbon bending, less than triple thickness of the ribbon.

13. The electric heating device of claim 10, wherein said flexible electrical heating resistance ribbon is capable of being bent at any angle with radius of ribbon bending equal zero.

14. The electric heating device of claim 10, wherein said flexible electrical heating resistance ribbon contains additional coating of electric enamel, whereby the ribbon constitutes an electrical insulated enameled strip.

15. The electric heating device of claim 14, further comprising an insulating shell enhousing said strip, whereby said heating device is provided with double insulation

16. The electrical heating device of claim 15,
wherein said shell is made of a plastics or synthetic or natural rubber.

17. The electrical heating device of claim 1, wherein said heating element comprises a basic material supporting said resistance ribbon such as to enable the element to be produced, as an insert separately from the shell either as a body insertable into said shell, or as a body adapted for impregnation by melting polymer or rubber mass, to form said shell, said ribbon being made from the metal alloy.

18. The electrical heating device of claim 17, wherein said basic material is in the form of two layers with said ribbon sandwiched therebetween, said layers and said ribbon being jointed together by parts of glued double sided stripes, which cross the heating ribbon, and the total area of the heating ribbon is larger than, an area of the stripes, contacting with the ribbon, in three and more times.

19. The electrical heating device of claim 17, wherein
said basic material is in the form of two layers with said ribbon sandwiched therebetween, said layers and said ribbon being jointed together by spots of a glue, which belongs to a group of cyan-acrylate glues and which is polymerized due to pressing; and the total area of the heating ribbon is larger than the area of said glued places, contacting with the ribbon, in three and more times.

20. The electrical heating device of claim 17, wherein
said basic material is in the form of two layers with said ribbon sandwiched therebetween, said layers and said ribbon being jointed together by thermoplastic strips, crossing the heating ribbon, which are melted and crowded to some places on the ribbon and on said layers in the joining process, and melt temperature of the thermoplastic strips is lower than melting temperature of the basic material, and the area of the heating ribbon is larger than the area of said places, contacting with the ribbon, in three and more times.

21. The electrical heating device of claim 17,
wherein said basic material is in the form of two layers with said ribbon sandwiched therebetween, said layers and said ribbon, being jointed together and sealed by polymer, which adhere to said basic material and does not adhere to said ribbon, and temperature of adhesive polymerization is lower than melting temperature of the basic material.

22. The electrical heating device of claim 17,
wherein the basic material is in the form of one layer, and the ribbon is jointed with said basic material by one of the following means: parts of glued double sided strips, spots of a cyan-acrylate glue, thermoplastic strips, and the total area of the ribbon is larger than the area of joined areas, in three and more times.

23. The electrical heating device of claim 17,
wherein said basic material comprises a thermoplastic layer, said material and said ribbon being jointed by beating and pressing of some places along the ribbon to the melting temperature of said layer, and the total, area of the heating ribbon is larger than the area of the heated places in three and more times.

24. The electrical heating device of claim 17,
wherein said insert is incorporated inside of said shell during a continuous calendaring process.

25. The electrical heating device of claim 17,
wherein said shell is made by laminating a number of layers on two sides of said insert simultaneously with incorporating the insert in a continuous laminating process.

26. The electrical heating device of claim 17,
wherein said shell is a rubber shell and said insert is incorporated inside of said rubber shell during the vulcanization process.

27. The electrical heating device of claim 17,
wherein said shell is a plastics sheath and said insert is incorporated inside of said plastics sheath during the continuous extrusion process, whereby said device is obtained in the form of a heating strip.

28. The electrical beating device of claim 27,
wherein the insert comprises said resistance ribbon, two additional electro-conductive metal ribbons incorporated in the sheath simultaneously with the resistance ribbon during the same extrusion process and located on two sides of said resistance ribbon, and bridges connecting said resistance ribbon with each of said electro-conductive ribbons by turns, forming longitudinally extending parallel resistances, whereby said device is obtained in the form, of a heating strip of an extended length.

29. The electrical heating device of claim 27, wherein said stip is made in the form of a plurality of heating sections, each constituting said electric heating device, wherein said insert is common for all the sections and further contains bus-bars made as flexible metal ribbons disposed along said insert, and each heating section has its own said resistance ribbon, the heating sections being connected with said bus-bars in parallel, said strip being adapted for being cut between said sections depending on required electrical power and length.

30. The electrical heating device of claim 17,
wherein ends of the resistance ribbon are connected with electro-conductive bus-bars, and said bus-bars are each made as a flexible metal ribbon and are disposed along said insert on two sides of said resistance ribbon, said bus-bars forming at least two pairs of terminals for connections of several heating devices one to another and with power supply.

31. The electrical heating device of claim 17,
wherein said device constitutes a beating section of a roll, the roll comprising a plurality of such heating sections, wherein said insert is common for all the sections and further contains bus-bars made as flexible metal ribbons disposed along said insert, and each heating section has its own said resistance ribbon, each of the heating sections is connected with said bus-bars in parallel, said roll being adapted for being cut between said sections depending on required electrical power.

32. The electrical heating device of claim 1,
wherein said structure to be heated has a rigid base having two sides, and may be one of the following: heated floor, heated wall, heated ceiling, plywood, gypsum or stone panels, said device being one of a plurality of heating devices for heating said structure, in each such, device said shell being adapted for tight mounting on one side of the rigid base, the other side of said rigid base containing markings indicating the disposition of the heating devices from behind to prevent using different fasteners, such as nails, screws etc. in the areas of the heating devices, and the heating devices are electrically connected each other by pairs of terminals.

33. The electrical heating device of claim 32,
wherein said rigid base contains holes for passing of said fasteners at locations spaced from said heating devices.

34. The electrical heating device of claim 17, wherein said shell is in the form of layers of resin disposed on, two sides of said insert, said insert reinforcing said resin, the shell and the insert are adapted for simultaneous polymerization when provided with, a predetermined shape, enabling said device to take shapes of flat or three-dimensioned structures.

35. An electrical heating device comprising a heating resistance ribbon made of an alloy of claim 4, incorporated in, an insulating shell in the form of a waterproof heat shrinkable sleeve, which fits snuggly said ribbon, forming a waterproof strip.

36. The electrical heating device of claim 35,
wherein the heating ribbon is coated by an electric enamel, forming a waterproof double-insulated strip.

37. An electrical heating device comprising a heating resistance ribbon made of an alloy of claim 4, incorporated in an waterproof extruded plastics sheath during extrusion process, forming a continuous waterproof strip.

38. The electrical heating device of claim, 37,
wherein the plastics sheath comprises two extruded layers, rendering said strip double-insulated.

39. The electrical heating device of claim 37,
wherein said ribbon is coated by an electric enamel, rendering said strip double-insulated.

40. The electrical heating device of claim 37,
which further contains an additional metal ribbon incorporated in said sheath simultaneously with the resistance ribbon during the same extrusion process.

41. The electrical heating device of claim 37, further comprising two ductile wires incorporated in said sheath simultaneously with the resistance ribbon during the same extrusion process and located on two sides of said ribbon, providing easy bending of the strip.

42. The electrical heating device of claim 37,
wherein said heating strip is bent into a plurality of lines to form a heating mat, and all said lines are joined in said mat by narrow bars.

43. An electrical heating device comprising a heating resistance ribbon made of an alloy of claim 4, coated by at least one layer of liquid silicon rubber mass.

44. The electrical heating device of claim 43,
wherein said ribbon is coated by electric enamel and said layer of liquid silicon, rubber mass covers said enamel.
